(19) United States
(12) Patent Application Publication
(10) Pub. No.: US 2018/0228202 A1
(43) Pub. Date: Aug. 16, 2018

(54) EDIBLE PRINT SUBSTRATES AND METHODS OF MAKING AND USING THE SAME

(71) Applicant: The Lucks Company, Tacoma, WA (US)

(72) Inventors: Megan Leifson, Tacoma, WA (US); Mimi Fielding, Gig Harbor, WA (US)

(21) Appl. No.: 15/898,051

(22) Filed: Feb. 15, 2018

Related U.S. Application Data
(60) Provisional application No. 62/459,512, filed on Feb. 15, 2017.

(51) Int. Cl. A23P 20/15; C09D 11/30; C09D 11/14; B41J 2/01; B41M 5/00; B41M 7/00; B41J 3/407; A23P 20/10

(52) U.S. Cl. CPC A23P 20/15; C09D 11/30; C09D 11/14; A23P 20/105; B41M 5/0047; B41M 7/0072; B41J 3/407; B41J 2/01

(57) ABSTRACT

The embodiments disclosed herein relate to edible print substrates. The edible print substrates can include a base layer and a print layer. The base layer can include one or more starches, celluloses, dextrins, fats, sugars, humectants or plasticizers, or emulsifiers, or combinations thereof. The print layer can include one or more starches, celluloses, corn syrups or corn syrup solids, fats, humectants or plasticizers, or emulsifiers, or combinations thereof.

### RELATED APPLICATIONS

This application claims priority to U.S. Provisional Application No. 62/459,512, filed on Feb. 15, 2017 and titled “EDIBLE PRINT SUBSTRATES AND METHODS OF MAKING AND USING THE SAME,” which is incorporated herein by reference in its entirety.

### TECHNICAL FIELD

The present disclosure relates generally to edible print substrates. In certain embodiments, the edible print substrates can be printed upon and disposed on a foodstuff such as a cookie or a cake. Methods of making and using edible print substrates are also disclosed herein.

### BRIEF DESCRIPTION OF THE DRAWINGS

The embodiments disclosed herein will become more fully apparent from the following description and appended claims, taken in conjunction with the accompanying drawings. These drawings depict only typical embodiments, which will be described with additional specificity and detail through use of the accompanying drawings in which:

FIG. 1 is a cross-sectional view of an edible print substrate, according to one embodiment of the present disclosure.

FIG. 2 is a cross-sectional view of an edible print substrate, according to another embodiment of the present disclosure.

FIG. 3 is a photograph of an edible print substrate, according to an embodiment of the present disclosure.

FIG. 4 is a photograph of an edible print substrate, according to another embodiment of the present disclosure.

FIG. 5 is a photograph of an edible print substrate, according to another embodiment of the present disclosure.

### DETAILED DESCRIPTION

The various embodiments disclosed herein relate to edible print substrates and methods of making and using the same. As detailed below, the edible print substrates can include, or otherwise be formulated from, one or more starches, celluloses, dextrins, sugars, fats, humectants or plasticizers, or emulsifiers, or combinations thereof. After forming and/or shaping the formulation (or formulations) into the one or more edible print substrates, an edible-ink printing system, such as a thermal ink-jet printer, piezo-electric printer, or other computer-controlled printing device, can be used to print an image onto the edible print substrates, allowing custom images and decorations to be prepared at a bakery on an as-needed basis. The edible print substrates can then be disposed on a variety of different foodstuffs, including but not limited to, cookies, cakes, cupcakes, brownies, pies, and other pastries.

As used herein, the term “image” shall mean any graphic, textual, or other decorative matter, without limitation, including writing and photographs, that may be applied to the edible print substrate. The term “printing” and “printing method” shall mean any method of applying an image to the edible print substrates, including, without limitation, screen printing, thermal ink-jet printing, piezo-electric printing, offset printing, lithography, laser printing, electrostatic printing, xerographic printing, holography, pad printing, thermal transfer, air brushing, and manual decoration techniques. These and other printing techniques can be used to print images on the edible print substrates by someone skilled in the various printing arts. For example, U.S. Pat. No. 4,668,523 to Begleiter describes methods for forming holograms in edible substances.

In some embodiments, the edible print substrates are formulated such that the image(s) disposed or printed thereon is substantially stable. A stable or substantially stable image can refer to an image that does not substantially change (e.g., bleed, fade, etc.) over time, or an image in which the change is minimal. For example, the image(s) can remain substantially constant or unchanged (or otherwise minimally changed) over time, e.g., when stored at room temperatures (e.g., between about 64° F. and about 78° F.) or when subjected to temperatures above or below room temperatures, such as refrigerator temperatures when placed in a refrigerator (e.g., between about 32° F. and about 40° F.) or freezer temperatures when placed in a freezer (e.g., between about −10° F. and about 2° F.).

In further embodiments, the edible print substrates are formulated such that the image(s) disposed or printed thereon is substantially unaffected (or otherwise minimally affected) by moisture (e.g., water and/or liquids) and/or oils in or on the foodstuff. In other words, the edible print substrates can be formulated such that moisture and/or oils from the foodstuff does not substantially flow or migrate through the edible print substrate to affect the image(s) disposed or printed thereon. For example, the edible print substrates (or a layer thereof) can be formulated to retard or prevent migration of moisture and/or oils through the edible print substrate (or a layer thereof), which can result in a protected or more stable image.

As further detailed below, in some embodiments the edible print substrates can be formed into multi-layer constructions. Further, in some embodiments, the edible print substrates can be formed into multi-layer constructions having two or more different layers, each of which can be formulated to provide desired, and in some instances different, properties to the edible print substrate. For example, one or more layers can be formulated to provide barrier properties or protection against the flow or migration of moisture and/or oils from the foodstuff. One or more layers can also be formulated for increased image printability and/or stability. For example, one or more layers can be formulated with a desired or controlled pH, which can be advantageous in stabilizing the image(s) disposed or printed on the edible print substrate.

For the purposes of promoting an understanding of various principles of the disclosure provided herein, reference will now be made to the embodiments illustrated in the drawings and specific language will be used to describe the same. It will be readily understood with the aid of the present disclosure that the components of the embodiments, as generally described and illustrated in the figures herein, could be arranged and designed in a wide variety of different configurations. Thus, the following more detailed description of various embodiments, as represented in the figures, is not intended to limit the scope of the disclosure, but is merely representative of various embodiments. In some cases, well-known structures, materials, or operations are not shown or described in detail. While the various aspects of the embodiments are presented in drawings, the drawings are not necessarily drawn to scale unless specifically indicated.

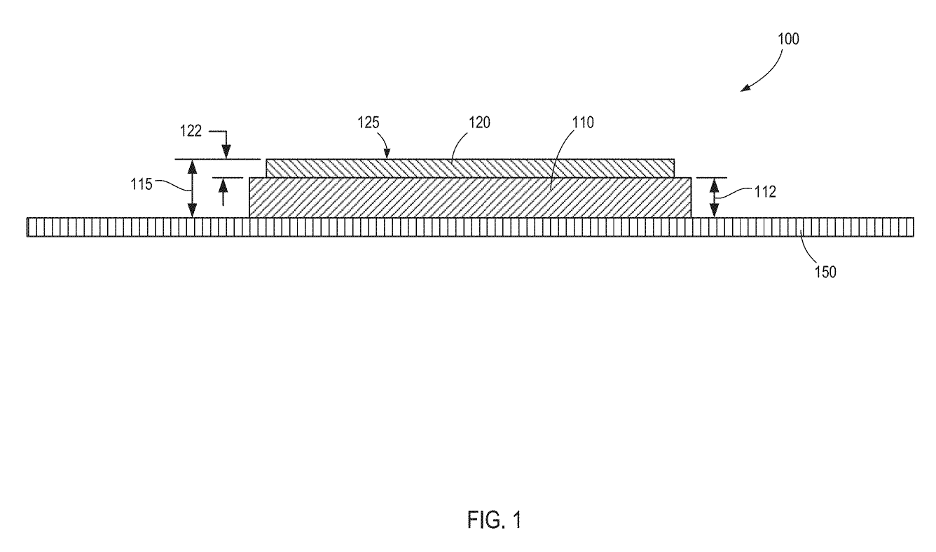

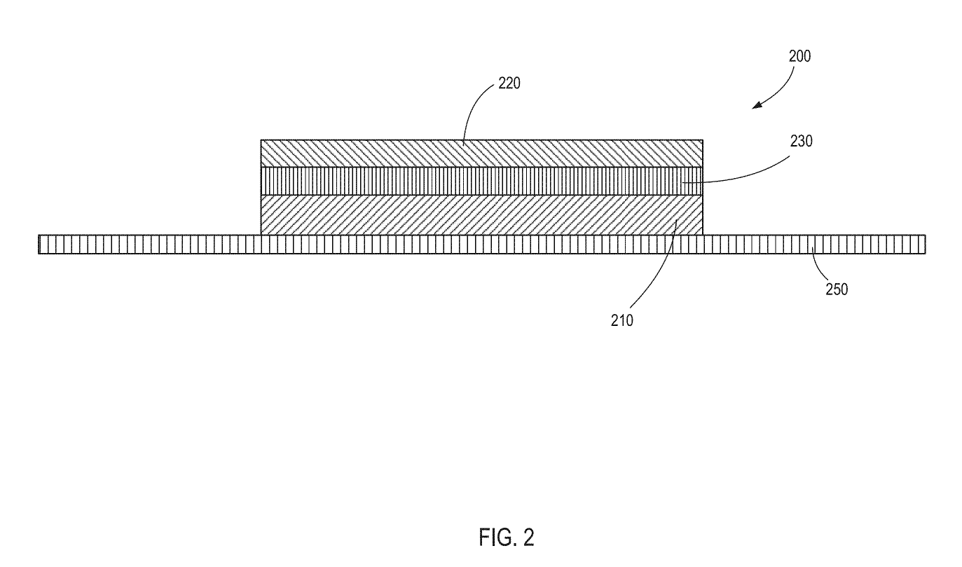

FIG. 1 depicts an edible print substrate 100 in accordance with an embodiment of the present disclosure. As shown in FIG. 1, the edible print substrate 100 can include a multi-layer construction which includes at least a base layer 110 and a print layer 120. It will be appreciated, however, that the formulations disclosed herein can also be used to form an edible print substrate having a single layer construction, or an edible print substrate having a multi-layer construction with 3 or more layers (such as is shown in FIG. 2).

As further detailed below, in some embodiments, the base and print layers 110, 120 are formulated with one or more different components (or amounts of components), such that the base and print layer 110, 120 are configured to exhibit different properties and/or characteristics. For example, the base layer 110 can be formulated to exhibit stronger (e.g., stiffer) and moisture resistant properties and/or characteristics, while the print layer 120 can be formulated to exhibit colorant-absorbent properties and/or characteristics. Thus, in some embodiments, the base layer 110 can be configured such that it does not readily absorb moisture or colorants, while the print layer 120 can be configured such that it readily absorbs colorants. In particular embodiments, the base layer 110 can be formulated to be hydrophobic.

In certain embodiments, the print layer 120 is formulated to have an absorbency that absorbs and/or inhibits smearing of food-grade colorants (also called “edible inks,” “edible pigments,” or “edible dyes”) used to print images on the edible print substrate 100. The print layer 120 also can be formulated to be pH neutral (e.g., pH 6-8) to avoid chemical reactions between the print layer 120 and colorants that cause changes in hue and chroma of the colorants. In contrast, in certain embodiments, the base layer 110 can be configured as a barrier layer. For example, the base layer 110 can be formulated to have an absorbency that is different from the absorbency of the print layer 120 to retard or prevent migration of moisture and/or oils from the foodstuff into the print layer 120. For instance, after being disposed onto a foodstuff, which can include frosting or topping such as a buttercream or whipped frosting or topping (e.g., high whip topping), the base layer 110 can be configured to retard or prevent migration of moisture and/or oils from the frosting (or topping) and/or foodstuff into the print layer 120. Retarding the migration of moisture and/or oils can reduce diffusion of colorants within the print layer 120 and into the base layer 110 and foodstuff, which can reduce blurring of the images over time.

In some embodiments, the base layer 110 includes or is otherwise formed from a base formulation. The base formulation can include various components or ingredients, each of which can impart one or more properties and/or characteristics to the edible print substrate 100. In some embodiments, for example, the base formulation includes one or more starches, celluloses, dextrins, sugars, fats, humectants or plasticizers, or emulsifiers, or combinations thereof. Additional components (e.g., gums, water, additives, etc.) can also be included in the base formulation as desired.

In certain embodiments, the base formulation includes one or more starches. Starches can serve as the base or structure forming material of the base formulation. Starches can also be used as fillers or thickening materials to modify the viscosity of the base formulation. For example, the type and/or amount of starches can impact the texture and/or moisture content of the base formulation. Exemplary starches include, but are not limited to, tapioca starch, corn starch, wheat starch, rice starch, potato starch, and derivatives and/or combinations thereof. The starches can also be refined or unrefined, modified or unmodified, as desired. For example, in certain embodiments, modified corn starch can be used. In some embodiments, the base formulation comprises between about 18% and about 33%, between about 20% and about 30%, or between about 22% and about 27%, by weight of the one or more starches such as tapioca starch. In further embodiments, the base formulation includes a combination of two or more starches. For example, the base formulation can include a first starch, second starch, third starch, etc., the total of which can be between about 18% and about 33%, between about 20% and about 30%, or between about 22% and about 27% by weight of the base formulation. Other combinations and/or amounts of starches can also be included in the formulation.

In some embodiments, the base formulation includes one or more celluloses. Celluloses can provide toughness to the base formulation, and enable the base formulation to flex and/or bend without cracking. In some embodiments, the celluloses used are celluloses other than basic cellulose, such as microcrystalline cellulose, carboxymethyl cellulose (or cellulose gum), methyl cellulose, hydroxypropyl methyl cellulose, and derivatives and/or combinations thereof. Use of such celluloses can result in an observable improvement in the amount of fading and/or bleeding (e.g., decreased fading and/or decreased bleeding) of the images disposed on the edible print substrates 100. In some embodiments, the base formulation comprises between about 4% and about 20%, between about 2% and about 10%, or between about 5% and about 15%, by weight of the one or more celluloses. In certain embodiments, the base formulation includes a combination of two or more celluloses. For example, the base formulation can include between about 2% and about 10%, or between about 4% and about 7%, by weight of a first cellulose such as microcrystalline cellulose, and between about 2% and about 8%, or between about 4% and about 5.5%, by weight of a second cellulose such as carboxymethyl cellulose (or cellulose gum). Other combinations and/or amounts of celluloses can also be included in the base formulation. Other polysaccharide compounds can also be used in addition to or in place of the one or more celluloses. Additionally, one or more forms of algae such as seaweed can be used in addition to or in place of the one or more celluloses.

In some embodiments, the base formulation includes one or more dextrins. Exemplary dextrins include, but are not limited to maltodextrins and derivatives thereof. In certain embodiments, maltodextrins having a particular dextrose equivalent (DE) are included in the base formulation. As can be appreciated, dextrose equivalent (DE) is a measure of the amount of reducing sugars present in the maltodextrins, relative to dextrose (glucose), expressed as a percentage of the dry substance weight. In certain embodiments, the base formulation includes one or more maltodextrins having a DE of between about 5 and about 20. In other embodiments, the base formulation includes one or more maltodextrins having a DE of between about 5 and about 15. In still further embodiments, the base formulation includes one or more maltodextrins having a DE of between about 8 and about 12. And in yet another embodiment, the base formulation includes one or more maltodextrins having a DE of about 5, about 10, or about 15.

A particular amount of maltodextrins can also be included in the base formulation. For example, in certain embodiments, the base formulation includes between about 10% and about 20%, or between about 12% and about 18%, by weight of maltodextrins. In other embodiments, the formulation includes between about 13% and about 16% by weight of maltodextrins. Other amounts of maltodextrins can also be used. Further, in certain embodiments, use of maltodextrins can have a positive and/or beneficial effect on the fading and/or bleeding of images disposed on the edible print substrates 100.

In some embodiments, one or more waxes can be included in the base formulation. Waxes can include organic compounds that are hydrophobic. Waxes can include alkanes and lipids. Waxes can also be malleable solids at or around room temperatures, and can be used in powder form. Exemplary waxes include, but are not limited to, animal waxes (e.g., beeswax, etc.), plant waxes (e.g., carnauba wax, soy wax, candelilla wax, etc.), petroleum waxes (e.g., paraffin wax, etc.), and derivatives and/or combinations thereof. In certain embodiments, for example, the base formulation comprises between about 0.1% and about 6%, between about 0.5% and about 5%, or between about 1% and about 3%, by weight of one or more waxes such as carnauba wax. Other amounts of wax can also be used. In other embodiments, the base formulation is devoid or free of waxes.

In some embodiments, one or more lipids, fats, fatty acids, or fatty acid derivatives can be used in the base formulation. Low and/or high melting point fats can be used. For example, one or more fats having a low melting point can be included in the base formulation. Low melting point fats can include natural, fully or partially hydrogenated, and/or fractionated edible vegetable and/or animal fats and oils having a melting point of less than 120° F., less than 110° F., less than 100° F., or less than 95° F. Exemplary low melting point fats include, but are not limited to, fatty acids or fatty acid derivatives, triglycerides (or triglycerides of fatty acids), coconut oil, rapeseed oil, soybean oil, palm oil, shortening, palm oil shortening, palm kernel oil, sunflower oil, corn oil, canola oil, cottonseed oil, peanut oil, cocoa butter, anhydrous milkfat, lard, beef fat, and derivatives and/or combinations thereof. In certain embodiments, for example, the base formulation comprises between about 2% and about 10%, between about 3% and about 9%, or between about 4% and about 8%, by weight of low melting point fats such as coconut oil and/or palm oil shortening. Other amounts of low melting point fats can also be used.

In some embodiments, two or more low melting point fats are used. For example, in one embodiment, the base formulation comprises between about 1% and about 5%, or between about 2% and about 4%, by weight of a first low melting point fat (e.g., coconut oil), and between about 1% and about 5%, or between about 2% and about 4%, by weight of a second low melting point fat (e.g., palm oil shortening). The melting points of the two or more low melting point fats can also differ from one another.

In some embodiments, one or more fats having a higher melting point can be included in the base formulation. High melting point fats can include natural, fully or partially hydrogenated, and/or fractionated edible vegetable and/or animal fats and oils having a melting point of greater than 250° F., greater than 275° F., or greater than 300° F. The high melting point fats can also be in powder form at room temperature. Exemplary high melting point fats include, but are not limited to, fatty acids or fatty acid derivatives, triglycerides (or triglycerides of fatty acids), stearic acid, calcium stearate, and derivatives and/or combinations thereof. In certain embodiments, for example, the base formulation comprises between about 0.5% and about 5%, or between about 1% and about 3%, by weight of high melting point fats such as calcium stearate. Other amounts of high melting point fats can also be used.

In certain embodiments, the base formulation includes a combination of one or more low melting point fats and one or more high melting point fats. In one embodiment, for example, the base formulation comprises between about 2% and about 10% by weight of one or more low melting point fats (e.g., coconut oil and/or palm oil shortening), and between about 0.5% and about 5% by weight of high melting point fats (e.g., calcium stearate). And in a particular embodiment, the base formulation comprises at least three fats having different melting points. For example, the base formulation can comprise two or more fats having low melting points, which can differ from one another (e.g., coconut oil and palm oil shortening), and at least one fat having a high melting point (e.g., calcium stearate).

In certain embodiments, the base formulation includes a combination of one or more starches, one or more celluloses, one or more fats, and one or more dextrins. For example, in a particular embodiment, the base formulation includes tapioca starch, microcrystalline cellulose, carboxymethyl cellulose (or cellulose gum), one or more low melting point fats, one or more high melting point fats, and maltodextrin. Other combinations of starches, celluloses, fats, and dextrins can also be included in the base formulation as desired.

As previously discussed, the base formulation can also include one or more sugars. In certain embodiments, for example, sugars are used to sweeten the base formulation. Sugars can also impart strength and elasticity to the base formulation. Exemplary sugars include, but are not limited to, sucrose, dextrose, fructose, invert sugars (or inverted sugars), and derivatives and/or combinations thereof. Other known sugars can also be used. In certain embodiments, the base formulation includes between about 2% and about 15%, or between about 4% and about 10%, by weight of sugars. One or more sweeteners (or sugar substitutes) can also be included to sweeten the base formulation in addition to or in place of the one or more sugars. For example, the base formulation can include between about 2% and about 10%, or between about 4% and about 7%, by weight of sugars, and between about 2% and about 8%, or between about 3% and about 5.5%, by weight of a sweetener such as sorbitol.

The base formulation can also include one or more humectants or plasticizers. In some embodiments, humectants or plasticizers are used to help maintain a proper water content within the base formulation, e.g., so that the base formulation is less susceptible to cracking and/or crumbling. Humectants or plasticizers can also be used to impart flexibility and/or a peeling functionality to the base formulation. As further detailed below, for example, the base formulation can be formed and/or shaped into edible print substrates 100, which can be disposed on a carrier 150. After being printed upon, the edible print substrates 100 can be peeled from the carrier 150 and disposed on a foodstuff. In such embodiments, one or more humectants or plasticizers can be used to impart flexibility and peelability such that the edible print substrates 100 maintain their shape and/or structure while being peeled from the carrier 150. Exemplary humectants or plasticizers include, but are not limited to, polyhydric alcohols, glycerin (or glycerine), polyethylene glycol, monoglycerides (or fatty monoglycerides, or monoglycerides of fatty acids), and derivatives and/or combinations thereof. Other humectants or plasticizers can also be used.

In a particular embodiment, the base formulation includes glycerin. Further, a particular amount of glycerin (and/or other humectants or plasticizers) can be included in the base formulation. For example, in some embodiments, the base formulation comprises between about 2% and about 10%, between about 4% and about 8%, or between about 5% and about 7% by weight of humectants or plasticizers such as glycerin. Other amounts of glycerin (and/or other humectants or plasticizers) can also be used.

One or more emulsifiers can also be included in the base formulation. For example, in certain embodiments, one or more emulsifiers can aid in maintaining homogeneity in the base formulation. Emulsifiers can also improve the flow of the base formulation in liquid form during processing and act as release agents to reduce clinging to a carrier such as a backing sheet. Exemplary emulsifiers include, but are not limited to, polyglycerol esters of fatty acids, polysorbate (e.g., polysorbate 60, polysorbate 80, etc.), lecithin, mono and/or diglycerides (or mono and/or diglycerides of fatty acids), and derivatives and/or combinations thereof. In certain embodiments, for example, the base formulation includes between about 0.1% and about 3%, between about 0.1% and about 2%, between about 0.25% and about 1%, or between about 0.25% and about 0.75%, by weight of an emulsifier such as polyglycerol esters of fatty acids.

As previously discussed, in particular embodiments, the base formulation further includes one or more additional components. For example, water or another solvent can be used to dissolve and/or mix the one or more components of the base formulation. In one embodiment, the base formulation comprises between about 23% and about 40% by weight water or other solvent. In another embodiment, the formulation comprises between about 25% and about 35% by weight water or other solvent.

One or more additives can also be included in the base formulation. Exemplary additives include, but are not limited to, natural and/or artificial flavorings, sweeteners (e.g., sucralose, aspartame, acesulfame potassium (Ace-K), and/or rebaudioside A (Reb-A), sorbitol, etc.), coloring agents and/or color enhancing agents, preservatives, and combinations thereof. In some embodiments, for example, the base formulation includes between about 0.1% and about 3%, between about 0.1% and about 2%, or between about 1% and about 2% by weight of natural and/or artificial flavorings.

In certain embodiments, the base formulation further includes one or more coloring agents and/or color enhancing agents. Exemplary coloring agents and/or color enhancing agents include, but are not limited to, whiteners, colorants, inks, dyes, pigments, and combinations thereof. In certain embodiments, for example, the base formulation includes titanium dioxide, which can impart a white color or pigment to the base formulation. In a particular embodiment, the base formulation comprises between about 0.1% and about 3%, between about 0.1% and about 2%, or between about 1% and about 2% by weight of one or more coloring agents (and/or color enhancing agents) such as titanium dioxide.

In some embodiments, the base formulation further includes one or more preservatives. Preservatives can be used to increase the shelf-life of the base formulation and/or keep the base formulation from spoiling. In particular embodiments, for example, one or more preservatives can be included to inhibit microbial growth (e.g., yeast, mold, bacteria, etc.). Exemplary preservatives include, but are not limited to, citric acid, potassium sorbate, and combinations thereof. In a particular embodiment, for example, the base formulation comprises between about 0.01% and about 0.2% by weight of a first preservative such as citric acid, and between about 0.01% and about 0.2% by weight of a second preservative such as potassium sorbate. In another embodiment, the base formulation comprises between about 0.01% and about 0.15% by weight of a first preservative such as citric acid, and between about 0.01% and about 0.15% by weight of a second preservative such as potassium sorbate. In yet another embodiment, the formulation comprises between about 0.05% and about 0.1% by weight of a first preservative such as citric acid, and between about 0.05% and about 0.1% by weight of a second preservative such as potassium sorbate. Other combinations and/or amounts of preservatives can also be used.

In some embodiments, the base formulation further includes one or more buffering agents or pH buffering agents. Buffering agents can be used to help neutralize and/or stabilize the pH, or bring an acidic pH closer to neutral (e.g., pH 6-8). Exemplary buffering agents include, but are not limited to, sodium bicarbonate. In a particular embodiment, for example, the base formulation comprises between about 0.01% and about 1%, or between about 0.01% and about 0.5% by weight of a buffering agent such as sodium bicarbonate. In another embodiment, the base formulation comprises between about 0.05% and about 0.3% by weight of a buffering agent such as sodium bicarbonate. In yet another embodiment, the formulation comprises between about 0.1% and about 0.25%, or between about 0.1% and about 0.2%, by weight of a buffering agent such as sodium bicarbonate. Other types and/or amounts of buffering agents can also be used.

The print layer 120 can also include, or otherwise be formulated from, various components or ingredients, each of which can impart one or more properties and/or characteristics to the edible print substrates 100. In some embodiments, for example, the print layer 120 includes or is formulated from a print formulation that includes one or more starches, celluloses, corn syrups (or corn syrup solids), fats, humectants or plasticizers, or emulsifiers, or combinations thereof. Additional components (e.g., gums, water, additives, etc.) can also be included in the print formulation as desired.

In certain embodiments, the print formulation includes one or more starches. Starches can serve as the base or structure forming material of the print formulation. Starches can also be used as fillers or thickening materials to modify the viscosity of the print formulation. For example, the type and/or amount of starches can impact the texture and/or moisture content of the print formulation. Exemplary starches include, but are not limited to, tapioca starch, corn starch, wheat starch, rice starch, potato starch, and derivatives and/or combinations thereof. The starches can also be refined or unrefined, modified or unmodified, as desired. For example, in certain embodiments, modified corn starch can be used. In some embodiments, the print formulation comprises between about 13% and about 27%, or between about 18% and about 22%, by weight of the one or more starches such as tapioca starch. Other combinations and/or amounts of starches can also be included in the print formulation.

In some embodiments, the print formulation includes one or more celluloses. Celluloses can provide toughness to the print formulation, and enable the formulation to flex and/or bend without cracking. In some embodiments, the celluloses used are celluloses other than basic cellulose, such as microcrystalline cellulose, carboxymethyl cellulose (or cellulose gum), methyl cellulose, hydroxypropyl methyl cellulose, and derivatives and/or combinations thereof. Use of such celluloses can result in an observable improvement in the amount of fading and/or bleeding (e.g., decreased fading and/or decreased bleeding) of the images disposed on the edible print substrates 100. In some embodiments, the print formulation comprises between about 5% and about 15%, or between about 9% and about 12%, by weight of the one or more celluloses such as microcrystalline cellulose. Other combinations and/or amounts of celluloses can also be included in the print formulation. Other polysaccharide compounds can also be used in addition to or in place of the one or more celluloses. Additionally, one or more forms of algae such as seaweed can be used in addition to or in place of the one or more celluloses.

In certain embodiments, the print formulation includes corn syrup, or corn syrup solids. For example, corn syrup solids can be used to sweeten the print formulation. Corn syrup solids can also be used to provide added thickness and/or texture to the print formulation. In a particular embodiment, the print formulation includes between about 10% and about 22%, or between about 15% and about 17%, by weight of corn syrup or corn syrup solids.

In certain embodiments, the print formulation includes algin, alginic acid, or sodium alginate. For example, algin can be used to provide added thickness and/or texture to the print formulation. In a particular embodiment the print formulation includes between about 0.1% and about 3%, or between about 1% and about 2%, by weight of algin.

The print formulation can also include one or more humectants or plasticizers. In some embodiments, humectants or plasticizers are used to help maintain a proper water content within the print formulation, e.g., so that the formulation is less susceptible to cracking and/or crumbling. Humectants or plasticizers can also be used to impart flexibility to the print formulation. As further detailed below, for example, the print formulation can be formed and/or shaped into edible print substrates 100, which can be disposed on a carrier 150. After being printed upon, the edible print substrates 100 can be peeled from the carrier 150 and disposed on a foodstuff. In such embodiments, one or more humectants or plasticizers can be used to impart flexibility such that the edible print substrates 100 maintain their shape and/or structure while being peeled from the carrier 150. Exemplary humectants or plasticizers include, but are not limited to, polyhydric alcohols, glycerin (or glycerine), polyethylene glycol, monoglycerides (or fatty monoglycerides, or monoglycerides of fatty acids), and derivatives and/or combinations thereof. Other humectants or plasticizers can also be used.

In a particular embodiment, the print formulation includes glycerin. Further, a particular amount of glycerin (and/or other humectants or plasticizers) can be included in the print formulation. For example, in some embodiments, the print formulation comprises between about 0.5% and about 5%, or between about 1.5% and about 3.5%, by weight of humectants or plasticizers such as glycerin. Other amounts of glycerin (and/or other humectants or plasticizers) can also be used.

One or more emulsifiers can also be included in the print formulation. For example, in certain embodiments, one or more emulsifiers can aid in maintaining homogeneity in the print formulation. Emulsifiers can also improve the flow of the print formulation in liquid form during processing. Exemplary emulsifiers include, but are not limited to, polyglycerol esters of fatty acids, polysorbate (e.g., polysorbate 60, polysorbate 80, etc.), lecithin, mono and/or diglycerides (or mono and/or diglycerides of fatty acids), and derivatives and/or combinations thereof. In certain embodiments, for example, the print formulation includes between about 0.1% and about 3% by weight of an emulsifier such as polyglycerol esters of fatty acids. In another embodiment, the print formulation includes between about 1% and about 2% by weight of an emulsifier such as polyglycerol esters of fatty acids.

In some embodiments, one or more lipids, fats, fatty acids, or fatty acid derivatives (e.g., triglycerides or triglycerides of fatty acids) having a low melting point can be included in the print formulation. Low melting point fats can include natural, fully or partially hydrogenated, and/or fractionated edible vegetable and/or animal fats and oils having a melting point of less than 120° F., less than 110° F., less than 100° F., or less than 95° F. Exemplary low melting point fats include, but are not limited to, fatty acids or fatty acid derivatives, triglycerides (or triglycerides of fatty acids), coconut oil, rapeseed oil, soybean oil, palm oil, shortening, palm oil shortening, palm kernel oil, sunflower oil, corn oil, canola oil, cottonseed oil, peanut oil, cocoa butter, anhydrous milkfat, lard, beef fat, and derivatives and/or combinations thereof. In certain embodiments, for example, the print formulation comprises between about 0.5% and about 5%, or between about 1.5% and about 3.5%, by weight of low melting point fats such as canola oil. Other amounts of low melting point fats can also be used.

As previously discussed, in particular embodiments, the print formulation further includes one or more additional components. For example, water or another solvent can be used to dissolve and/or mix the one or more components of the print formulation. In one embodiment, the print formulation comprises between about 33% and about 47% by weight water or other solvent. In another embodiment, the print formulation comprises between about 38% and about 42% by weight water or other solvent.

One or more additives can also be included in the print formulation. Exemplary additives include, but are not limited to, natural and/or artificial flavorings, sweeteners (e.g., sucralose, aspartame, acesulfame potassium (Ace-K), and/or rebaudioside A (Reb-A), sorbitol, etc.), coloring agents and/or color enhancing agents, preservatives, and combinations thereof.

In some embodiments, for example, the print formulation further includes one or more preservatives. Preservatives can be used to increase the shelf-life of the print formulation and/or keep the print formulation from spoiling. In particular embodiments, for example, one or more preservatives can be included to inhibit microbial growth (e.g., yeast, mold, bacteria, etc.). Exemplary preservatives include, but are not limited to, citric acid, potassium sorbate, and combinations thereof. In a particular embodiment, for example, the print formulation comprises between about 0.01% and about 0.2% by weight of a preservative such as potassium sorbate. In another embodiment, the print formulation comprises between about 0.01% and about 0.15% by weight of a preservative such as potassium sorbate. In yet another embodiment, the print formulation comprises between about 0.05% and about 0.1% by weight of a preservative such as potassium sorbate. Other amounts and/or types of preservatives can also be used.

In some embodiments, the print formulation further includes one or more buffering agents, or pH buffering agents, such as sodium bicarbonate. In a particular embodiment, for example, the print formulation comprises between about 0.01% and about 0.3% by weight of buffering agents (e.g., sodium bicarbonate). In another embodiment, the print formulation comprises between about 0.05% and about 0.25% by weight of buffering agents (e.g., sodium bicarbonate). In yet another embodiment, the print formulation comprises between about 0.1% and about 0.2% by weight of buffering agents (e.g., sodium bicarbonate). Other amounts and/or types of additives can also be used.

As can be appreciated, the above-mentioned properties and/or characteristics imparted by the various components are intended to be illustrative and exemplary and not limiting in any way. Additionally, the various components may impart additional (or fewer) properties and/or characteristics to the base and/or print formulations, which may not be described herein. For example, citric acid can be included in the base formulation as a preservative and for its pH buffering aspects. Further, depending on the amount of each component, and the types of components present in the base and/or print formulations, a specific component can also be multi-functional and impart multiple properties and/or characteristics to the base and/or print formulations.

Further, as can also be appreciated, in certain embodiments, one or more substitutes of the above-mentioned components can be included in the base and/or print formulations. For example, in certain embodiments, natural substitutes of one or more of the above-mentioned components can be included if desired. For example, natural substitutes of titanium dioxide can include specialty starches (e.g., specialty rice starches), which can be used as a coloring agent. Other substitutes (natural or otherwise) that provide similar properties and/or characteristics to the above-mentioned components can also be used.

Methods of making and using edible print substrates 100 are also disclosed herein. In certain embodiments, for example, the above-mentioned base and/or print formulations, can be prepared and formed and/or shaped into one or more edible print substrates 100. One or more images can thereafter be printed upon the one or more edible print substrates 100, and the edible print substrates 100 can be disposed onto a foodstuff.

For example, in various embodiments, the base formulation can be formed by mixing the base formulation components in hot water. For example, the base formulation components can be added to water that is greater than about 85° F., greater than about 90° F., or greater than about 95° F. In certain embodiments, the water is between about 90° F. and about 100° F. The components can then be added and mixed to form an emulsion. For example, one or more components, such as the one or more fats can form an emulsion in the water and/or aqueous mixture. In some embodiments, a vacuum (or reduced pressure) is then applied to the formulation. A vacuum (or reduced pressure) can be used to remove gas, such as air or carbon dioxide, out of the emulsion or mixture. The resulting emulsion or mixture (which can be degassed) can be referred to as the base formulation, or fluid base formulation. In certain embodiments, degassing the mixture can provide a smooth formulation, or a formulation with little to no gas bubbles disposed therein. In other embodiments, no vacuum is used.

The base layer 110 can then be formed by depositing the fluid base formulation onto a carrier 150 to form a thin base film that, when dried, is flexible, freestanding and removably adhered to the carrier 150. The “carrier” 150 (also called a “backing sheet,” “backing paper,” “release paper,” or “carrier sheet”) can be a sheet of silicone coated paper, but may also be a wax-coated paper, a resin-coated paper, a plastic sheet or tablet, a sheet of metal foil, a stone slate, or any other article having a generally smooth surface to which the base layer 110 will removably adhere. In one embodiment, the fluid base formulation may be deposited on the carrier 150 using a screen casting method in which a screen printing device is used to directly deposit the base layer 110 onto the carrier 150 in its final shape and so that it has a substantially uniform base thickness 112. Alternatively, the base formulation may be deposited by filling an opening in a stencil made of plastic, metal, or other solid material. The base formulation may also be deposited using an extrusion process, a rotary screen printing process, a web coating process (e.g., knife over roll processing or gap coating, slot coating, roll to roll coating, etc.), a 3D printing process (or three-dimensional printing process), a lamination process (e.g., laminating a layer onto a backing sheet), a spray coating process (e.g., spraying the base formulation onto a backing sheet using, e.g., an air pressure spray system), or any other method of forming thin films of fluid substances. As used herein, the term “fluid” is broadly defined to mean any substance that will flow through openings in the screen casting device or other device used for forming the fluid substance into a thin film.

In embodiments using a screen casing method, for example, a squeegee of the screen printing device can be used to fill a printing opening in a printing screen of the screen printing device, which printing opening is bordered by a mask area of the printing screen. The printing screen has a mesh count and a thread diameter that affect the resulting thickness of the layer of the formulation deposited by the screen printing device. Other factors affecting the layer thickness include the thickness of the mask area of the printing screen, the moisture content of the formulation (which affects shrinkage during drying), and properties of the squeegee of the screen printing device such as its profile, operating angle, and the amount of pressure applied to it.

After the base formulation is deposited on the carrier 150 to form the base layer 110, it is preferably dried, for example by air drying, until its moisture content is reduced to between approximately 8 percent and 10 percent by weight. The print layer 120 can then be formed over the base layer 110, which, together with the print layer 120, comprises the edible print substrate 100.

The print formulation can be formed in various ways. For example, the print formulation can be formed by mixing the print formulation components in hot water. For instance, the print formulation components can be added to water that is greater than about 85° F., greater than about 90° F., or greater than about 95° F. In certain embodiments, the water is between about 90° F. and about 100° F. In some embodiments, the components can then be added and mixed to form an emulsion. For example, one or more components, such as the one or more fats can form an emulsion in the water and/or aqueous mixture. In some embodiments, a vacuum (or reduced pressure) is then applied to the formulation. A vacuum (or reduced pressure) can be used to remove gas, such as air or carbon dioxide, out of the emulsion. The resulting emulsion or mixture (which can be degassed) can be referred to as the print formulation, or fluid print formulation. In certain embodiments, degassing the mixture can provide a smooth formulation, or a formulation with little to no gas bubbles disposed therein. In other embodiments, no vacuum is used.

The print layer 120 can be formed by depositing a print formulation (which can also be referred to as a print layer formulation, a coating formulation, etc.) over the base layer 110 using a screen casting method or an alternative method, such stenciling, extrusion, rotary screen printing, web coating (e.g., knife over roll, slot coating, roll to roll, etc.), 3D printing (or three-dimensional printing), lamination process (e.g., laminating onto the base layer 110), a spray coating process (e.g., spraying the print formulation onto the base layer 110 using, e.g., an air pressure spray system), or any other method of forming a thin film over the base layer 110. It will also be appreciated that the method or process of depositing the print layer 120 (or any other layer (e.g., intermediate layer)) need not be performed using the same method or process that was used in depositing the base layer 110. For example, the base layer 110 can be deposited using a web coating process, such as a knife over roll process, and the print layer 120 can be deposited using a spray coating process, etc. When dried, the print layer 120 can permanently adhere to the base layer 110 opposite the carrier 150. The print layer 120 also can form a substantially flat, smooth, flexible outer major surface 125 of the edible print substrate 100 that is adapted to receive and carry colorants that are printed or otherwise applied to the edible print substrate 100 to form an image.

Further, the base layer 110 can be formed by depositing the base formulation in a single deposition step, or in two or more deposition steps, each followed by a drying step. Analogously, the print layer 120 (and any other layer (e.g., intermediate layer)) can be formed by depositing the print formulation (or intermediate formulation for formation of an intermediate layer) in one or more deposition steps, followed by further drying steps.

In one embodiment, the edible print substrate 100 is dried after deposition of the print formulation until the edible print substrate 100 has an overall moisture content of between about 7.4 percent and 8 percent by weight. However, the edible print substrate 100 may be dried to have a moisture content of between 6 and 10 percent by weight without significantly affecting the ability to print on the edible print substrate 100 or peel it from its carrier 150. Alternatively, the edible print substrate 100 may be packaged in a moist condition before drying or after partial drying, leaving the remainder of the drying to be performed by an end user of the edible print substrate 100, either before or after printing an image on the edible print substrate 100. When applied to a moist foodstuff such as a frosted cake, the finished edible print substrate 100 typically physically integrates with and/or bonds to the foodstuff, leaving the image intact.

The thickness 115 of the edible print substrate 100 can vary as desired. For example, in some embodiments, the overall thickness 115 of the edible print substrate 100 can be between about 160 microns and about 190 microns, between about 100 microns and about 250 microns, between about 100 microns and about 350 microns, between about 100 microns and about 400 microns, or between about 100 microns and about 2500 microns.

Further, in some embodiments, the print layer 120 may be formed to have a thickness 122 that is different from the base layer thickness 112, for example, by depositing the respective base and print layers 110, 120 using a screen casting process having two different printing screens, i.e., first and second printing screens, having different mesh counts, thread diameters, and/or mask area thicknesses. Differential thickness allows the edible print substrate 100 to be made with increased strength by maximizing the base layer thickness 112, while minimizing the thickness 122 of the weaker print layer 120. Differential thickness also allows the edible print substrate 100 to be manufactured so that cutability of the moisture barrier base layer 110 is maintained. Alternatively, the print thickness 122 (or print layer thickness) and base thickness 112 (or base layer thickness) may be made substantially equal. For example, in a screen casting method, the first and second printing screens may be equal in mesh count, thread diameter, and/or mask area thickness to achieve equal base and print thicknesses 112, 122. As previously discussed, other methods can also be used to deposit the layers 110, 120.

The following Table 1 lists possible ranges (in microns) for overall thickness 115, base thickness 112, and print thickness 122 of the edible print substrate 100 depicted in FIG. 1. It will, however, be appreciated that the ranges are exemplary and not meant to be exhaustive.

TABLE 1

| Overall Thickness | Base Thickness | Print Thickness |
|---|---|---|
| 160-190 microns | 80-95 microns | 80-95 microns |
| 350-400 microns | 270-300 microns | 80-100 microns |
| 100-250 microns | 80-190 microns | 20-60 microns |
| 100-400 microns | 80-250 microns | 20-150 microns |
| 100-2500 microns | 80-1800 microns | 20-700 microns |

It will be appreciated that the base formulation and print formulation, used to form the base layer 110 and print layer 120 respectively, can include any of the various components previously identified, in any of the amounts previously identified. For example, in certain embodiments, the base formulation may include citric acid in combination with another preservative (e.g., potassium sorbate), to retard spoilage of the base formulation during storage without affecting color stability of colorants applied the print layer 120. In some embodiments, the inclusion of citric acid may form a base formulation having a pH of less than 5, which can allow the base formulation to be stored at room temperature for more than 48 hours and for up to 5 days or more (e.g., up to 1 week or more) without spoiling. For example, in some embodiments, the base formulation may be formulated to have a pH of between about 4 to about 5. In other embodiments, the base formulation may be formulated to have a pH of between about 4.2 and about 4.5.

In other embodiments, one or more buffering agents, such as sodium bicarbonate, may be added to the base formulation such that the base formulation is pH neutral (e.g., pH 6-8). By the inclusion of a buffering agent such as sodium bicarbonate, the base formulation may also be formulated to have a pH between about 6 to about 8. In other embodiments, the base formulation may be formulated to have a pH of between about 6.5 and about 7.5.

In certain embodiments, the print formulation is devoid of citric acid. Further, as noted above, the print layer 120 may be formulated to be pH neutral. For example, in certain embodiments, the print layer 120 may be formulated to have a pH of between about 6 and about 8. In other embodiments, the print layer 120 may be formulated to have a pH of between about 6.5 and about 7.5. In yet other embodiments, the print layer 120 may be formulated to have a pH of between about 6.7 and about 6.9. In certain embodiments, the pH of the base formulation and the pH of the print formulation are substantially the same (e.g., within a pH of about 0.5 or about 1 of one another). For example, both the pH of the base formulation and the pH of the print formulation can be substantially pH neutral (e.g., pH 6-8). The base formulation and the print formulation can also be prepared separately and stored separately at room temperature, as necessary.

In further embodiments, the base formulation may also include a coloring agent such as titanium dioxide so that the base layer 110 forms an opaque white or solid-color background to an image printed on the print layer 120. Other coloring agents (e.g., red, orange, yellow, green, blue, purple, brown, black, etc.) can also be used to make a base formulation and/or base layer 110 having any desired color. Further, titanium dioxide and/or other coloring agents can allow the base layer 110 to remain substantially opaque, even after placement of the edible print substrate 100 on a moist foodstuff. In some of such embodiments, the print formulation in the print layer 120 may not include titanium dioxide and/or coloring agents so that the colorants applied to the print layer 120 retain their color value and are not dulled or diluted by mixing with titanium dioxide and/or other coloring agents in the coating formulation. The absence of titanium dioxide and/or other coloring agents in the print layer 120 can also allow the base layer 110 to show through the print layer 120 and serve as a background of a printed image.

In another embodiment, one or more intermediate layers may be formed between the base layer 110 and the print layer 120 by depositing an intermediate formulation on the base layer 110 before the print formulation is deposited. As can be appreciated, any of the above-mentioned methods and processes for depositing the base formulation and print formulation can be used in depositing the one or more he intermediate layers. The print formulation is then deposited over the base and intermediate layers. One or more intermediate layers may also be deposited to form laminates having 3, 4, 5 or more layers. The laminate edible print substrate 100 may be at least partly dried after deposition of each of the base 110, intermediate, and print layers 120. Intermediate layers allow the edible print substrate 100 to be built up in thickness for increased strength and improved color stability.

It is contemplated that processing of the edible print substrate 100 can be performed in whole or in part by an end user of the edible print substrate 100, or can be performed entirely by a manufacturer of the edible print substrate 100, prior to packaging and shipment to an end user. In one exemplary processing method, an edible print substrate 100 is dried until firm enough to be removed intact from the carrier 150. An edible colorant is then printed on the edible print substrate 100 to form an image. The printed edible print substrate 100 is then removed from the carrier 150 and applied to a foodstuff for presentation and consumption. If desired, the printed edible print substrate 100 can be formed into a 3-dimensional shape before presentation and consumption. In another exemplary processing method, the edible print substrate 100 is printed with an edible colorant to form an image, then dried until firm enough to be removed intact from the carrier 150. The printed, dried edible print substrate 100 is then removed from the carrier 150 and optionally formed into a 3-dimensional shape before application to a foodstuff for presentation and consumption. In yet another exemplary processing method, the edible print substrate 100 is dried and then optionally formed into a 3-dimensional shape before printing and application to a foodstuff for presentation and consumption. In still another exemplary processing method, the edible print substrate 100 is dried and a border image is printed, leaving an unprinted central area of outer major surface 125 of the edible print substrate 100. The edible print substrate 100 with border image is then packaged for shipment to an end user, who can add a personalized decoration or image to the central area by printing before applying the finished edible print substrate 100 to a foodstuff for presentation and consumption. In any of the embodiments, once the edible print substrate 100 has been at least partly dried, it can be stored at room temperature for at least 1 year in a sealed container without spoiling. Storage life can also be increased by decreasing the moisture content of the edible print substrate 100 before packaging.

FIG. 2 depicts an edible print substrate 200, according to another embodiment of the present disclosure. As shown in FIG. 2, in some embodiments, the edible print substrate 200 comprises a multi-layer construction comprising three or more layers 210, 220, 230, which can be deposited on a carrier or backing layer 250. For example, in the illustrated embodiment, the edible print substrate comprises a base layer 210, an intermediate layer 230, and a print layer 220. One or more additional intermediate layers 230 can also be included if desired.

Non-limiting examples of various formulations and/or edible print substrates disclosed herein are presented in the examples below:

### EXAMPLE 1

Several multi-layer edible print substrates were made using the following base and print formulations:

Each base formulation included ingredients within the following ranges:

| Ingredient | Amount (wt %) |
|---|---|
| 1. Water | 28-35% |
| 2. Tapioca Starch | 23-28% |
| 3. Maltodextrin having a DE of between 5-15 | 13.5-17.5% |
| 4. Sugar | 4-7% |
| 5. Microcrystalline Cellulose | 4-7% |
| 6. Cellulose Gum | 4-5.5% |
| 7. Glycerin | 4-5.5% |
| 8. Sorbitol | 4-5.5% |
| 9. Carnauba Wax | 0.1-3% |
| 10. Titanium Dioxide | 0.1-2% |
| 11. Polyglycerol Esters of Fatty Acids | 0.1-2% |
| 12. Natural and Artificial Flavors | 0.1-2% |
| 13. Citric Acid | 0.01-0.1% |
| 14. Potassium Sorbate | 0.01-0.1% |

The tapioca starch, maltodextrin, sugar, sorbitol, microcrystalline cellulose, cellulose gum, carnauba wax, titanium dioxide, and natural and artificial flavors were blended to achieve a substantially homogeneous mixture. The water, glycerin, polyglycerol esters of fatty acids, citric acid, and potassium sorbate were then added and blended with the mixture, yielding each base formulation.

An amount of each base formulation was then disposed on a carrier to achieve a base layer having a thickness of between about 80 microns and about 100 microns. The base layer was then at least partially dried. A print formulation, described below, was then disposed onto a surface of each base layer to yield a multi-layer edible print substrate.

Each print formulation included ingredients within the following ranges:

| Ingredient | Amount (wt %) |
|---|---|
| 1. Water | 38-42% |
| 2. Tapioca Starch | 18-22% |
| 3. Corn Syrup Solids | 15-17% |
| 4. Microcrystalline Cellulose | 9-12% |
| 5. Canola Oil | 1.5-3.5% |
| 6. Glycerin | 1.5-3.5% |
| 7. Polyglycerol Esters of Fatty Acids | 0.1-2% |
| 8. Algin | 0.1-2% |
| 9. Sodium Bicarbonate | 0.01-0.2% |
| 10. Potassium Sorbate | 0.01-0.1% |

The tapioca starch, corn syrup solids, microcrystalline cellulose, algin, and sodium bicarbonate were blended to achieve a substantially homogeneous mixture. The water, glycerin, canola oil, polyglycerol esters of fatty acids, and potassium sorbate were then added and blended with the mixture, yielding each print formulation.

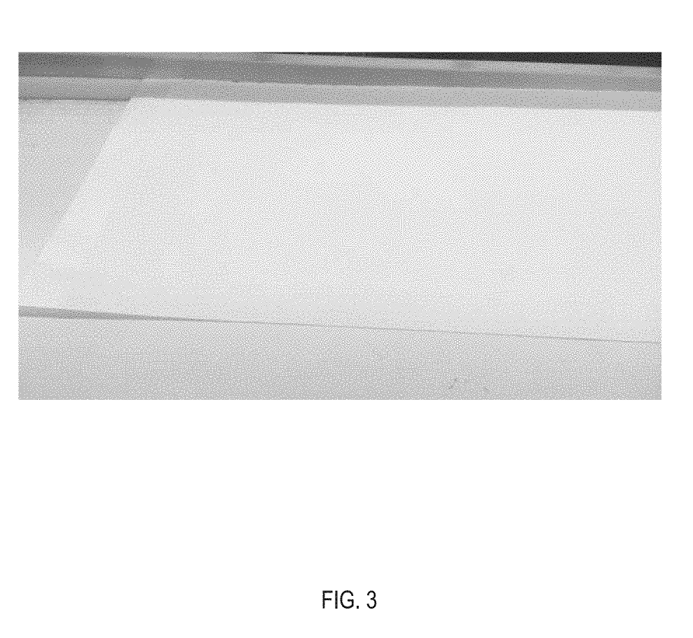

An amount of each print formulation was then disposed onto a surface of each base layer to achieve a print layer having a thickness of between about 80 microns and about 100 microns. Each resulting edible print substrate had an overall thickness of between about 160 microns and about 200 microns, and could be printed upon, or packaged and printed upon at a later date. An illustrative sheet of an edible print substrate is depicted in FIG. 3.

### EXAMPLE 2

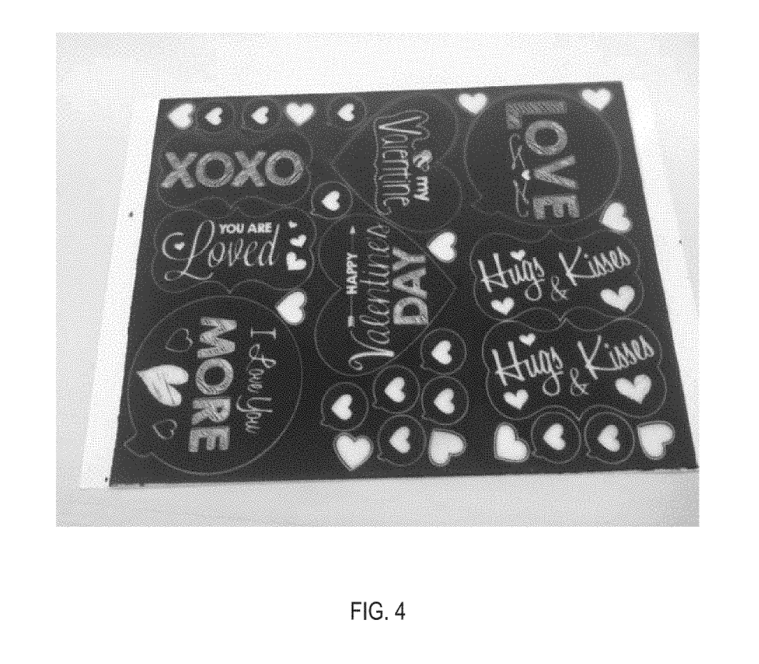

Samples of multi-layer edible print substrates produced in accordance with Example 1 were printed upon using an edible black ink. The edible print substrates were then treated with a laser (via methods of laser ablation) to produce the multi-layer edible print substrates depicted in FIG. 4. In particular, the black regions represent areas in which the print layer (having been printed upon with a black ink) remains as part of the edible print substrate. The white regions (e.g., words and shapes) represent areas in which the print layer has been removed or ablated by a laser, leaving at least a portion of the white base layer (which can be observed in the photograph) as part of the edible print substrate. The edible print substrates were then placed on various cakes and stored at different temperatures. In particular, some samples were stored at room temperature, some samples were stored at refrigeration temperatures, and other samples were stored at frozen temperatures. Minimal to no bleeding or fading of the ink was observed in any of the samples over a period of 48 hours.

### EXAMPLE 3

Several multi-layer edible print substrates were made using the following base and print formulations:

Each base formulation included ingredients within the following ranges:

| Ingredient | Amount (wt %) |
|---|---|
| 1. Water | 25-35% |
| 2. Tapioca Starch | 20-30% |
| 3. Maltodextrin having a DE of between 5-15 | 13-16% |
| 4. Sugar | 4-7% |
| 5. Microcrystalline Cellulose | 4-7% |
| 6. Cellulose Gum | 4-5.5% |
| 7. Glycerin | 4-8% |
| 8. Sorbitol | 3-5.5% |
| 9. First Low Melting Point Fat (Coconut Oil) | 2-4% |
| 10. Second Low Melting Point Fat (Palm Oil Shortening) | 2-4% |
| 11. High Melting Point Fat (Calcium Stearate) | 1-3% |
| 11. Titanium Dioxide | 0.1-2% |
| 12. Polyglycerol Esters of Fatty Acids | 0.1-2% |
| 13. Natural and Artificial Flavors | 0.1-2% |
| 14. Citric Acid | 0.01-0.2% |
| 15. Potassium Sorbate | 0.01-0.2% |
| 16. Sodium Bicarbonate | 0.1-0.25% |

The tapioca starch, maltodextrin, sugar, sorbitol, microcrystalline cellulose, cellulose gum, low and high melting point fats, titanium dioxide, and natural and artificial flavors were blended to achieve a substantially homogeneous mixture. The water, glycerin, polyglycerol esters of fatty acids, citric acid, potassium sorbate, a sodium bicarbonate were then added and blended with the mixture to form an emulsion. A vacuum was then applied to the mixture to degas the mixture, yielding each base formulation.

An amount of each base formulation was then disposed on a carrier to achieve a base layer having a thickness of between about 270 microns and about 300 microns. The base layer was then at least partially dried. A print formulation, described below, was then disposed onto a surface of each base layer to yield a multi-layer edible print substrate.

Each print formulation included ingredients within the following ranges:

| Ingredient | Amount (wt %) |
|---|---|
| 1. Water | 38-42% |
| 2. Tapioca Starch | 18-22% |
| 3. Corn Syrup Solids | 15-17% |
| 4. Microcrystalline Cellulose | 9-12% |
| 5. Canola Oil | 1.5-3.5% |
| 6. Glycerin | 1.5-3.5% |
| 7. Polyglycerol Esters of Fatty Acids | 0.1-2% |
| 8. Algin | 0.1-2% |
| 9. Sodium Bicarbonate | 0.01-0.2% |
| 10. Potassium Sorbate | 0.01-0.1% |

The tapioca starch, corn syrup solids, microcrystalline cellulose, algin, and sodium bicarbonate were blended to achieve a substantially homogeneous mixture. The water, glycerin, canola oil, polyglycerol esters of fatty acids, and potassium sorbate were then added and blended with the mixture, yielding each print formulation.

An amount of each print formulation was then disposed onto a surface of each base layer to achieve a print layer having a thickness of between about 80 microns and about 100 microns. Each resulting edible print substrate had an overall thickness of between about 350 microns and about 400 microns, and could be printed upon, or packaged and printed upon at a later date.

### EXAMPLE 4

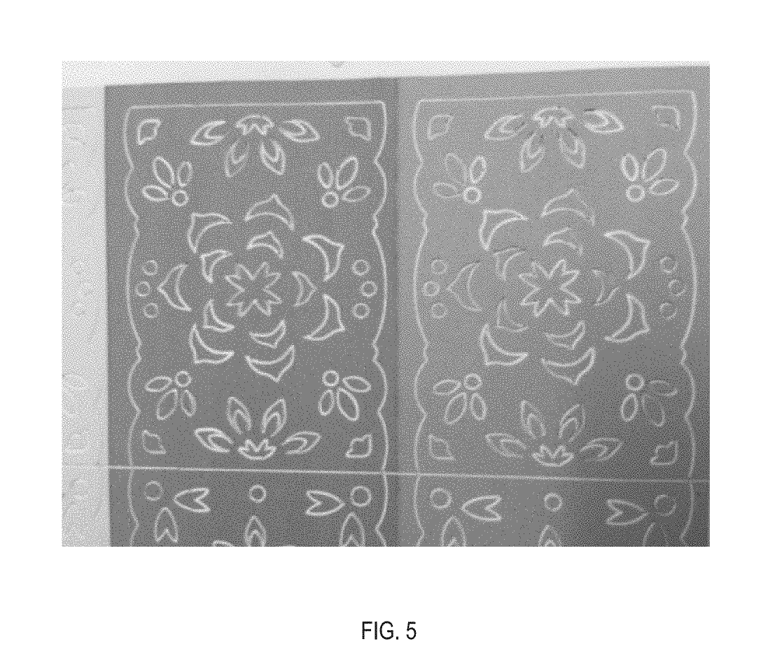

Samples of multi-layer edible print substrates produced in accordance with Example 3 were printed upon using edible colored inks. The edible print substrates were then treated with a laser (via methods of laser ablation) to produce multi-layer edible print substrates. The edible print substrates were then treated with a laser (via methods of laser ablation) to produce the multi-layer edible print substrates depicted in FIG. 5. In particular, the dark regions represent areas in which the print layer (having been printed upon with a colored ink) remains as part of the edible print substrate. The white regions (e.g., shape outlines) represent areas in which the print layer has been removed or ablated by a laser, leaving at least a portion of the white base layer (which can be observed in the photograph) as part of the edible print substrate. The edible print substrates were then placed on various cakes and stored at different temperatures. In particular, some samples were stored at room temperature, some samples were stored at refrigeration temperatures, and other samples were stored at frozen temperatures. Minimal to no bleeding or fading of the ink was observed in any of the samples over a period of 48 hours.

Without further elaboration, it is believed that one skilled in the art can use the preceding description to utilize the invention to its fullest extent. The claims and embodiments disclosed herein are to be construed as merely illustrative and exemplary, and not a limitation of the scope of the present disclosure in any way. It will be apparent to those having ordinary skill in the art, with the aid of the present disclosure, that changes may be made to the details of the above-described embodiments without departing from the underlying principles of the disclosure herein. In other words, various modifications and improvements of the embodiments specifically disclosed in the description above are within the scope of the appended claims. The scope of the invention is therefore defined by the following claims and their equivalents.

What is claimed is:

1. An edible print substrate, comprising:
a base layer comprising a base formulation, comprising:
a starch;
a cellulose;
a dextrin;
a low melting point fat;
a high melting point fat; and
a print layer comprising a print formulation, comprising:
a starch;
a cellulose; and
a humectant or plasticizer.

2. The edible print substrate of claim 1, wherein the dextrin comprises a maltodextrin having a DE of between about 5 and about 20.

3. The edible print substrate of claim 1, wherein the low melting point fat comprises a melting point less than 120° F.

4. The edible print substrate of claim 1, wherein the high melting point fat comprises a melting point greater than 250° F.

5. The edible print substrate of claim 1, further comprising a second low melting point fat.

6. The edible print substrate of claim 5, wherein the base formulation comprises between about 1% and about 5% by weight of the low melting point fat, between about 1% and about 5% by weight of the second low melting point fat, and between about 0.5% and about 5% by weight of the high melting point fat.

7. The edible print substrate of claim 1, wherein the base formulation further comprises a coloring agent.

8. The edible print substrate of claim 1, wherein the base formulation further comprises a preservative.

9. The edible print substrate of claim 1, wherein the print formulation further comprises corn syrup solids.

10. The edible print substrate of claim 1, wherein the print formulation further comprises one or more lipids or triglycerides.

11. The edible print substrate of claim 1, wherein the pH of the base layer is between about 6 and about 8, and the pH of the print layer is between about 6 and about 8.

12. A method of forming a multi-layer edible print substrate, comprising:
depositing a base formulation onto a carrier to form a base layer, wherein the base formulation comprises:
a starch;
a cellulose;
a dextrin; and
a low melting point fat;
a high melting point fat; and
depositing a print formulation to form a print layer, wherein the print formulation comprises:
a starch;
a cellulose; and
a humectant or plasticizer.

13. The method of claim 12, further comprising:
depositing an intermediate formulation to form an intermediate layer between the base layer and the print layer.

14. The method of claim 12, wherein the dextrin comprises a maltodextrin having a DE of between about 5 and about 20.

15. The method of claim 12, wherein the low melting point fat comprises a melting point less than 120° F.

16. The method of claim 12, wherein the high melting point fat comprises a melting point greater than 250° F.

17. The method of claim 16, further comprising a second low melting point fat.

18. The method of claim 17, wherein the base formulation comprises between about 1% and about 5% by weight of the low melting point fat, between about 1% and about 5% by weight of the second low melting point fat, and between about 0.5% and about 5% by weight of the high melting point fat.

19. The method of claim 12, wherein the print formulation further comprises corn syrup solids.

20. A method of forming a multi-layer edible print substrate, comprising:
mixing base formulation components to form an emulsion, wherein the base formulation components comprise:
a starch;
a cellulose;
a dextrin; and
a low melting point fat;
a high melting point fat; and
subjecting the emulsion to reduced pressure to remove gas from the emulsion.
